(19) United States
(12) Patent Application Publication
(10) Pub. No.: US 2003/0034057 A1
(43) Pub. Date: Feb. 20, 2003

(54) Cleaning apparatus

(76) Inventor: Po-Lin Liao, Taichung (TW)

Correspondence Address: Andrew CHENG, 22928 Estoril Drive # 5, Diamond Bar, CA, 91765, US

(21) Appl. No.: 09/930,579

(22) Filed: Aug. 15, 2001

(51) Int. Cl. B08B 3/04; B08B 7/04

(52) U.S. Cl. 134/95.2; 134/102.1; 134/98.1

(57) ABSTRACT

A cleaning apparatus for selectively applying cleaning foam, cleaning water and compressed air toward a working surface includes a housing incorporated with a mixing pump having inlet manifold and outlet port thereon. Water and compressed air sources are connected to said inlet manifold of the mixing pump, and a cleaning agent tank is arranged in the housing and interconnected to said inlet manifold of the mixing pump so as to create cleaning foam when needs. Wherein cleaning foam, clear water and compressed air can be selectively output during a cleaning cycle so as to economically perform the cleaning process.

### FIELD OF THE INVENTION

The present invention relates to a cleaning apparatus, and more particularly to a cleaning apparatus including a foam generating device so as to facilitate quick cleaning dirt from a workpiece.

### DESCRIPTION OF THE PRIOR ART

Conventionally, in order to clean a radiator of a vehicle, a cleaning agent is firstly added into a tank having water therein so as to creating cleaning foam and cleaning solution. Then water is firstly deployed over an entire surface of the radiator to flush portion of the dirt. Then the cleaning solution is applied toward area on which the dirt is still there. After dirt, grease or other debris are decomposed by the cleaning foam and solution from the attached area, water jet is directed and injected again so as to remove the foam as well as the debris from the surface.

This is not an economic way to cleanse the radiator or other workpiece in a commercial scale because of the labor, time involved.

### SUMMARY OF THE INVENTION

An objective of this invention is to provide a cleaning apparatus in which cleaning foam is directly created during the cleaning process so as to economically and efficiently facilitate cleaning job.

In order to achieve the objective set forth, a cleaning apparatus for selectively applying cleaning foam, cleaning water and compressed air toward a working surface in accordance with the present invention includes a housing incorporated with a mixing pump having inlet manifold and outlet port thereon. Water and compressed air sources are connected to said inlet manifold of the mixing pump, and a cleaning agent tank is arranged in the housing and interconnected to said inlet manifold of the mixing pump so as to create cleaning foam when needs. Wherein cleaning foam, clear water and compressed air can be selectively output during a cleaning cycle so as to economically perform the cleaning process.

### BRIEF DESCRIPTION OF THE DRAWINGS

Other objects and further features of the present invention will be apparent from the following detailed description when read in conjunction with the accompanying drawings, in which:

FIG. 1 is a circuit chart of a cleaning apparatus in accordance with the present invention;

FIG. 2 is similar to FIG. 1 in which a cleaning foam cycle is generated;

FIG. 3 is similar to FIG. 2 in which a cleaning water cycle is generated;

FIG. 4 is similar to FIGS. 2 and 3 in which a drying air cycle is generated; and

FIG. 5 is a perspective view of a cleaning apparatus in accordance with the present invention.

### DETAILED DESCRIPTION OF THE PREFERRED EMBODIMENT

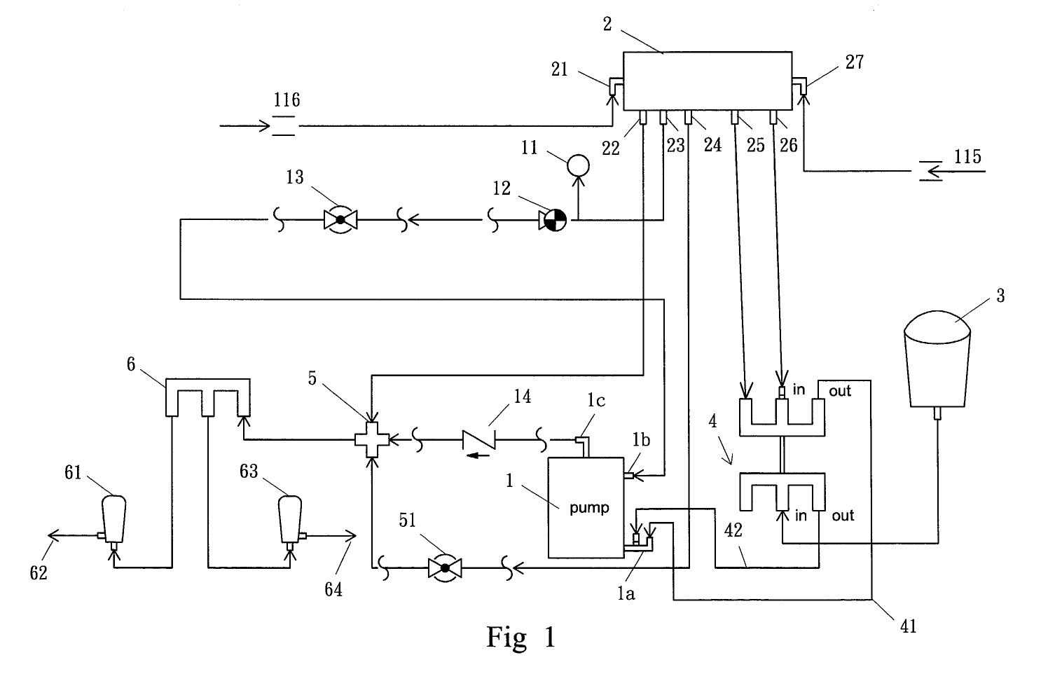

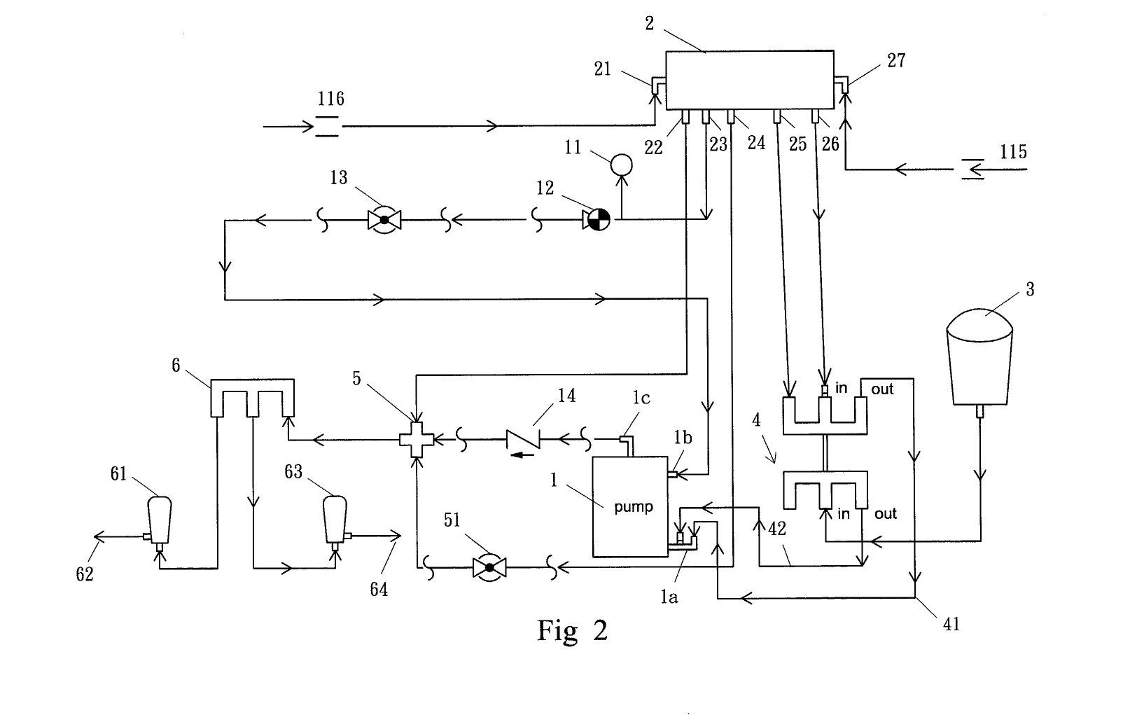

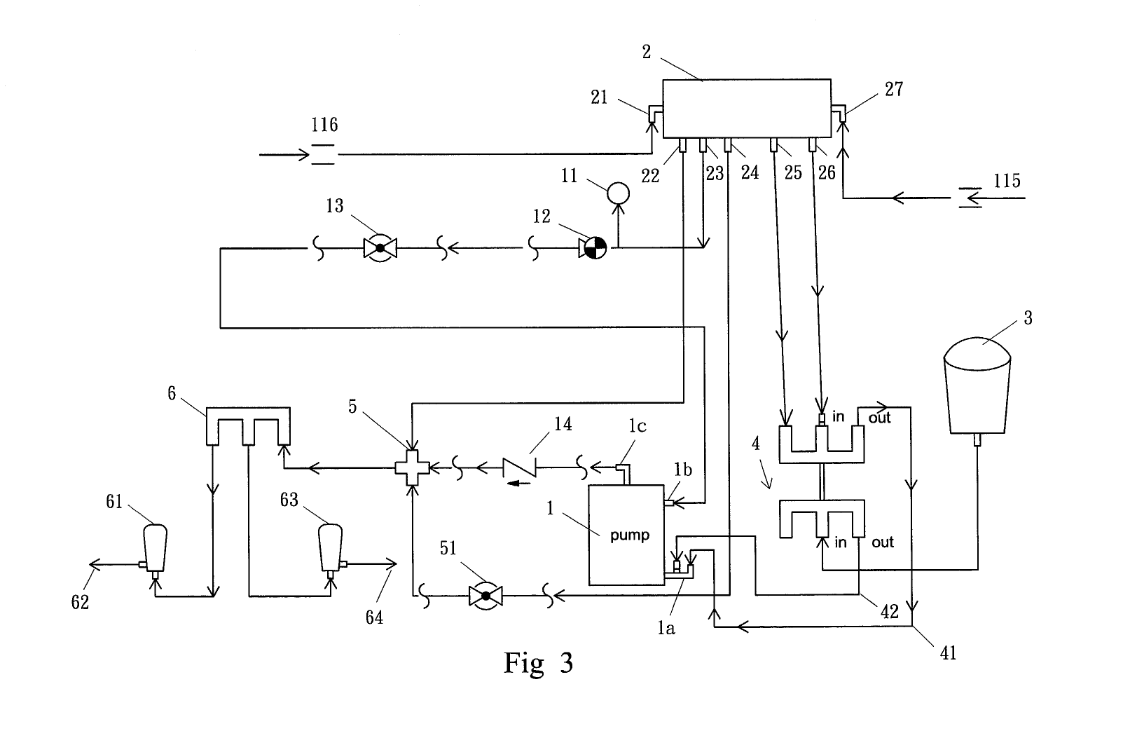

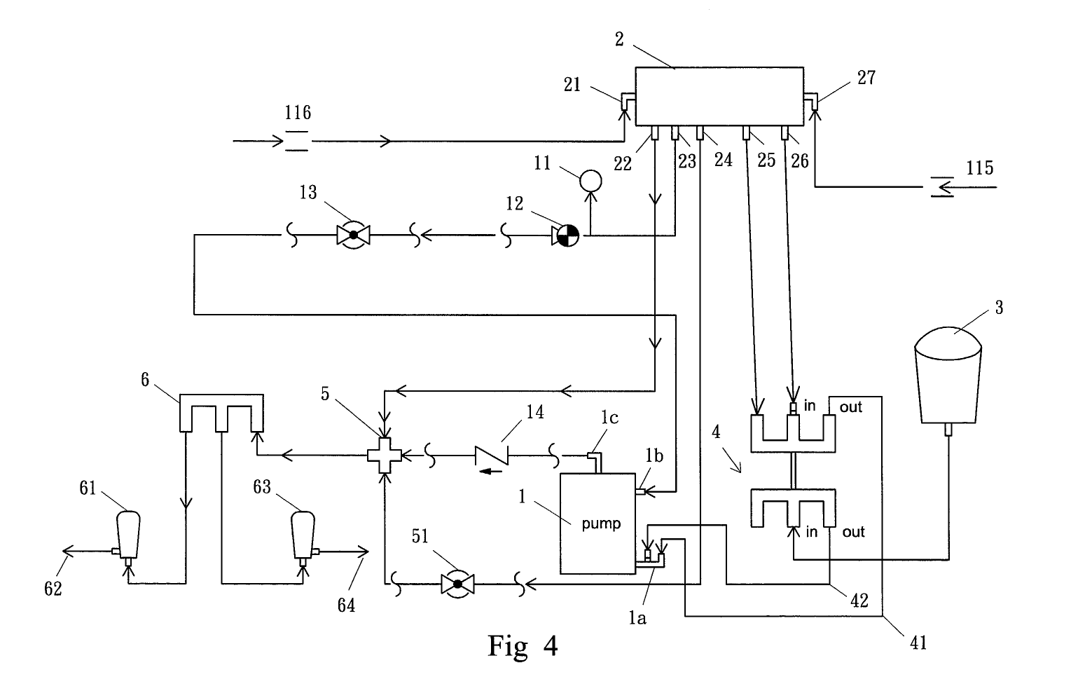

Referring to FIGS. 1 to 5, a cleaning apparatus 100 for selectively applying cleaning foam, cleaning water and compressed air toward a working surface in accordance with the present invention includes a housing 110 incorporated with a mixing pump 1 having inlet manifold 1a and 1b and outlet port 1c thereon. Water 115 and compressed air 116 sources are connected to the inlet manifold 1a of the mixing pump 1 via valves and conduits which will be detailed described hereinafter.

The housing 110 includes a 7-way valve 2 in which the water 115 and compressed air 116 are connected to the inlet 27 and 21 through suitable conduits (not labeled). The housing 110 further includes a synchronic 3-way valve 4 in which water conduits 25 and 26 are connected thereto. After the water 115 flows through the 3-way valve 4, it flows into the inlet manifold la of the pump 1a.

A cleaning agent tank 3 is arranged in the housing 110 and interconnected to the inlet manifold 1a of the mixing pump 1 so as to create cleaning through the pump 1. The cleaning agent contained within the tank 3 flows into the pump 1 through the 3-way valve 4, and then the conduit 42, and finally flows into the inlet manifold 1b of the pump 1.

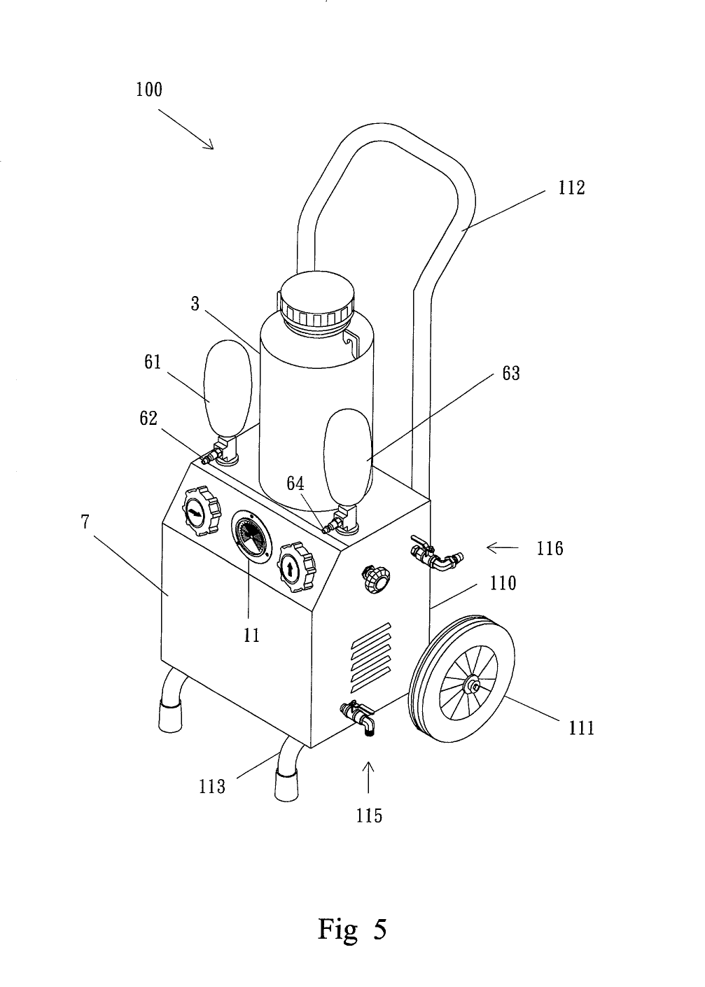

The compressed air 116 is introduced into the cleaning apparatus 100 through an inlet, as shown in FIG. 5. The compressed air then flows through the 7-way valve 2, and then through a regulator 13 via a conduit 23, a ball-type one-way valve 14, a 4-way valve 5, and finally into the inlet manifold 1b of the pump 1.

The conduit 23 is further connected with a pressure gauge 11 so as to check the pressure of the compressed air 116.

During the first cleaning mode, the water 115, the compressed air 116 and the cleaning agent are simultaneously directed into the pump 1 so as to generate cleaning foam/solution within the pump 1. The cleaning foam/solution is then pumped out of the pump 1 through the outlet 1c and directed to a 3-way valve 6, and finally applied to a surface of a workpiece (not shown) through a nozzle 64. However, in order to properly apply the cleaning foam/solution onto the working surface, a regulating pump 63 is arranged right before the nozzle 64 such that the cleaning foam/solution is kept with certain pressure so as to properly clean the working surface.

After the certain period of time, the cleaning agent and the compressed air 116 can be shut off such that only the water 115 flows through the entire system. Accordingly, only water 115 will be ejected from the nozzle 64 after it is regulated. With the pressurized water 115 applied toward the working surface, the cleaning foam together with other dirt and debris will be simultaneously flushed out. Finally, the water 115 and the cleaning agent are both shut off such that only compressed air 116 are introduced into the system. The compressed air 116 will be regulated at the regulating pump 61 and finally ejected out of the system through the nozzle 62 so as to dry out the working surface.

During the drying mode, the compressed air 116 will not flow through the pump 1, but flows through the conduit 22 firstly, and then through the 4-way valve 5, the 3-way valve 6, and the regulating pump 61 and finally out of the system through the nozzle 62.

The present invention can be concluded at least the following advantages.

1) Since the cleaning foam/ solution can be directly generated during the cleaning mode, there is no need to prepare the cleaning foam/solution anymore. In addition, the cleaning foam/solution can be accurately controlled so as to save more money and reduce the negative impact to the environment.

2) Those three modes can be economically performed so as to reduce the usage of the water.

3) Since the cleaning processes can be readily performed through the cleaning apparatus, labor cost is largely reduced.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

I claim:

1. A cleaning apparatus, comprising
a mixing pump having inlet manifold and outlet port;
a water source connected to said inlet manifold of the mixing pump;
a compressed air inlet connected to said inlet manifold of the mixing pump;
a cleaning agent connected to said inlet manifold of the mixing port;
wherein said water source, said compressed air and cleaning agent can be selectively added to said pump so as to generate cleaning agent foam when those three sources are added, or cleaning water when cleaning agent and compressed are shut off, or drying air when both said water and said cleaning agent are shut off.

2. A cleaning apparatus as recited in claim 1, wherein controlling valves are arranged between those three sources and inlet manifold so as to control those sources to the pump.

3. A cleaning apparatus as recited in claim 1, wherein said outlet port includes a cleaning foam outlet and a water/air mixture outlet.

4. A cleaning apparatus as recited in claim 1, wherein a cleaning agent tank is incorporated.

5. A cleaning apparatus as recited in claim 3, wherein a pressure regulating pump is incorporated after said mixing pump to eject the water/air mixture and cleaning foam under a certain pressure.

6. A cleaning apparatus, comprising
a housing;
a mixing pump arranged within the housing and having inlet manifold and outlet port;
a water source connected to said inlet manifold of the mixing pump;
a compressed air inlet connected to said inlet manifold of the mixing pump;
a cleaning agent tank having cleaning agent arranged in the housing and interconnected to said inlet manifold of the mixing pump;
wherein cleaning foam, clear water and compressed air can be selectively selected during a cleaning cycle so as to economically perform the cleaning process.

7. The cleaning apparatus as recited in claim 6, wherein said housing further includes a pair of wheels and a handle for easy movement of the apparatus.

8. The cleaning apparatus as recited in claim 6, wherein a multi-port valve is arranged between the compressed air and water sources and the mixing pump.

9. The cleaning apparatus as recited in claim 8, wherein a synchronic 3-way valve is arranged between the multi-port valve and the mixing pump.

10. The cleaning apparatus as recited in claim 9, wherein the cleaning agent is introduced into the mixing pump through the synchronic 3-way valve.

11. The cleaning apparatus as recited in claim 6, wherein the cleaning apparatus further includes a first regulating pump connected to the outlet of the mixing pump.

12. The cleaning apparatus as recited in claim 11, wherein a 3-way valve is arranged between the mixing pump and the regulating pump.

13. The cleaning apparatus as recited in claim 12, wherein the cleaning apparatus further includes a second regulating pump connected to the 3-way valve.

14. The cleaning apparatus as recited in claim 12, wherein bypass route is arranged between the multi-port valve and the 3-way valve for the compressed air.
